(19) United States
(12) Patent Application Publication
(10) Pub. No.: US 2008/0222132 A1
(43) Pub. Date: Sep. 11, 2008

(54) PERSONALIZED SHOPPING RECOMMENDATION BASED ON SEARCH UNITS

(76) Inventors: Jiangyi Pan, Fremont, CA (US); Wei Du, Sunnyvale, CA (US); Joydeep Sen Serma, Sunnyvale, CA (US); Shyam Kapur, Sunnyvale, CA (US)

Correspondence Address: YAHOO! INC.;C/O DREIER LLP, 499 PARK AVENUE, NEW YORK, NY, 10022, US

(21) Appl. No.: 11/683,301

(22) Filed: Mar. 7, 2007

(51) Int. Cl. G06F 17/30

(52) U.S. Cl. 707/5; 707/3; 707/E17.059

(57) ABSTRACT

The present invention is directed towards systems and methods for generating recommendations in response to one or more users based on user search queries. The method of the present invention comprises generating a recommendation model based on aggregate activity generated though use of a network resource. A user profile is generated based on an individual user's interaction with said network resource. A user query is received and the previously generated recommendation model in combination with the previously generated user profile are utilized to provide a recommendation relevant to the user search query and global statistics.

### CROSS REFERENCE TO RELATED APPLICATIONS

The present application is related to the following commonly owned U.S. patents and patent applications:

U.S. patent application Ser. No. 11/295,166, entitled “SYSTEMS AND METHODS FOR MANAGING AND USING MULTIPLE CONCEPT NETWORKS FOR ASSISTED SEARCH PROCESSING,” filed on Dec. 5, 2005 and assigned attorney docket no. 7346/41US;

U.S. patent application Ser. No. 10/797,586, entitled “VECTOR ANALYSIS OF HISTOGRAMS FOR UNITS OF A CONCEPT NETWORK IN SEARCH QUERY PROCESSING,” filed on Mar. 9, 2004 and assigned attorney docket no. 7346/54US;

U.S. patent application Ser. No. 10/797,614, entitled “SYSTEMS AND METHODS FOR SEARCH PROCESSING USING SUPERUNITS,” filed on Mar. 9, 2004 and assigned attorney docket no. 7346/56US;

U.S. Pat. No. 7,051,023, entitled “SYSTEMS AND METHODS FOR GENERATING CONCEPT UNITS FROM SEARCH QUERIES,” filed on Nov. 12, 2003; and

U.S. Pat. No. 6,873,996, entitled “AFFINITY ANALYSIS METHOD AND ARTICLE OF MANUFACTURE,” filed on Apr. 16, 2003;

The disclosures of which are hereby incorporated by reference herein in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The personalization of data for Internet users is an increasingly common request from both consumers and producers of Internet goods. As the technologies that underlie the Internet increasingly shift towards dynamic design, the personalized recommendations of content based on a user's activity have become particularly in demand.

Despite this demand, however, current recommendation schemes have yet to match the pace at which web development has grown. Current schemes rely on user behavior categorization and modeling to generate recommendations relevant to browsing users. This technique reduces the relevancy of the recommendations and thus provides results that are not as effective as possible. Specifically, the categorization and modeling of user behavior results in a rough grained input set as opposed to a fine grained input set containing a greater amount of detail regarding user behavior.

Another unsatisfactory technique of generating recommendations based on user behavior results from current techniques of basing recommendations on the actual clicks of a given user. By generating recommendations based solely on the actual clicks of a given user, the shopping intention of the user is essentially ignored and thus results in an inaccurate depiction of user behavior or an over-generalized view of user activity. For example, if a user searches for the query “Christmas presents for a baby girl” and clicks on a resulting link for a mobile or for a rattle, basing a recommendation solely on the user clicks will result in recommendations for those specific items. This methodology would ignore the query for a specific type of gift (a Christmas present) and would return recommendations for only specific items (mobile or rattle). Furthermore, this methodology would eliminate the “Christmas present” aspect of the search which may be useful in determining recommendations related to popular Christmas presents for infants that were not thought of by the user.

Current recommendation schemes also place requirements on the metadata utilized to generate recommendations. This requirement results in a loss of approximately 80% or useful user response data. By utilizing a strict metadata scheme, an application loses a substantial amount of its dynamics and severely hampers intelligent recommendations.

Thus, there is currently a need in the art to provide a recommendation system that overcomes these deficiencies. In particular, there is a need to utilize raw search data of a given user, that is, raw search queries, not simply categories of searches. Accordingly, embodiments of systems and methods in accordance with the present invention are operative to provide recommendations that are tailored a specific search queries.

### SUMMARY OF THE INVENTION

The present invention is directed towards systems and methods for generating relevant recommendations for one or more users based on user search queries. The system of the present invention comprises a plurality of client devices and one or more network resources coupled to a network.

According to one embodiment, a recommendation unit is coupled to the network and operative to generate a recommendation model on the basis of aggregate activity generated with the network resource. The recommendation unit may comprise a click unit for capturing user click data, a query unit for capturing user queries and an affinity engine operative to generate a recommendation model based on received click data and user query, the data and query corresponding to the interaction of a user with the network resource. A recommendation data store is provided to store the recommendation model that the recommendation unit generates.

In one embodiment, the affinity engine comprises a query affinity engine operative to generate associations between user search queries and click data. The affinity engine further comprises a unit generator operative to receive a search query and extract units from said search query via an extraction algorithm. The affinity engine further comprises a unit affinity engine coupled to a the unit generator operative to receive the extracted units and generate associations between units and click data and a conceptual affinity engine coupled to a unit generator operative to receive the extracted units and generate conceptual units, wherein said conceptual affinity engine is further operative to generate associations between conceptual units and click data. The affinity engine may also contain a model generator coupled to the query affinity engine, unit affinity engine and conceptual affinity engine and operative to form at least one recommendation model.

A user profile unit may be coupled to the network and operative to generate statistics related to an individual user's interaction with a network resource. In accordance with one embodiment, the user profile unit comprises a search history construction unit operative to retrieve a subset of user search history. The subset of user search history may comprise a subset based on a predetermined date range.

A user profile unit may further comprise a unit generator operative to receive a search query and extract predefined units from said search query via an extraction algorithm. The unit generator may comprise a frequency unit operative to assign a frequency to each extracted unit. The units may comprise a dictionary specific to the network resource being utilized. In one embodiment, an all-possible algorithm may comprise the extraction algorithm. In alternative embodiments, a left-longest algorithm may comprise the extraction algorithm.

A recommendation server is coupled to the network and operative to receive user activity, which may comprise real-time user activity, and generate recommendations related to the user activity. In a one embodiment, a recommendation server comprises an identification unit operative to retrieve a recommendation model and user profile, recommendation logic operative to generate recommendations for the user (as well as select a subset of said recommendations) and combination logic operative to combine the generated recommendations into a resulting recommendation list. The generated recommendations may comprise recommendations based on raw user queries, on units generated from raw user queries, from conceptual units generated from raw user queries or any combination thereof. The recommendation server may further comprise a business rule unit operative to apply editorial rules to the operations of the recommendation server. In one embodiment the editorial rules may comprise a filter for incoming queries. In an alternative embodiment, the editorial rules may comprise adjusting a rank parameter for an incoming query.

The present invention is further directed towards a method for generating relevant recommendations to one or more users based on user search queries. The method according to one embodiment of the present invention comprises generating a recommendation model based on aggregate activity generated through use of a network resource. The recommendation mode may be formed from user click data and corresponding queries. An affinity is generated between a user query and an associated click. According to various embodiments, an affinity is determined between raw queries and items, between units and items and between conceptual units and items. The affinities associated with raw queries, units and conceptual units may then be combined to form a recommendation model.

A user profile may be generated based on an individual user's interaction with said network resource. A subset of the search history is retrieved and units are extracted from the subset of the search history via an extraction algorithm. The subset of a user's search history may comprise a subset selected within a predetermined date range. The predetermined units may correspond to a dictionary specific to said network resource. In one embodiment, the extraction algorithm may comprise an all-possible algorithm. In an alternative embodiment, the extraction algorithm may comprise a left-longest algorithm.

A weight may be applied to a generated unit, which may then be stored within a user profile data store. Upon generating a unit, a frequency may be attached to the unit corresponding to the number of times the unit has been seen. This frequency may be attached to the corresponding unit and stored within the user profile data store.

A user query is received and recommendations are provided by utilizing a recommendation model and a user profile. A recommendation model and user profile are retrieved from external storage and recommendations are generated based on both the recommendation model and the user profile. A subset of the generated recommendations may be selected from the generated recommendations. The final recommendation list may be generated based on a raw user query, units based on a raw user query, conceptual units based on a raw user query or any combination thereof.

Business rules may be utilized to apply editorial rules to the operation of generating a recommendation based on a user query. In one embodiment, editorial rules comprise a filter for incoming data. In an alternative embodiment, editorial rules comprise adjusting a rank parameter for each query.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram illustrating one embodiment of a system for generating recommendations for users based on search queries according to one embodiment of the present invention;

FIG. 2 illustrates a block diagram illustrating one embodiment of an affinity engine for generating a recommendation model according to one embodiment of the present invention;

FIG. 3 illustrates a flow diagram illustrating one embodiment of a method for generating a recommendation model based on user activity according to one embodiment of the present invention;

FIG. 4 illustrates a flow diagram illustrating one embodiment of a method for generating a user profile based on user behavior according to one embodiment of the present invention; and

FIG. 5 illustrates a flow diagram illustrating one embodiment of a method for generating recommendations based on a user query according to one embodiment of the present invention.

### DETAILED DESCRIPTION OF THE INVENTION

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

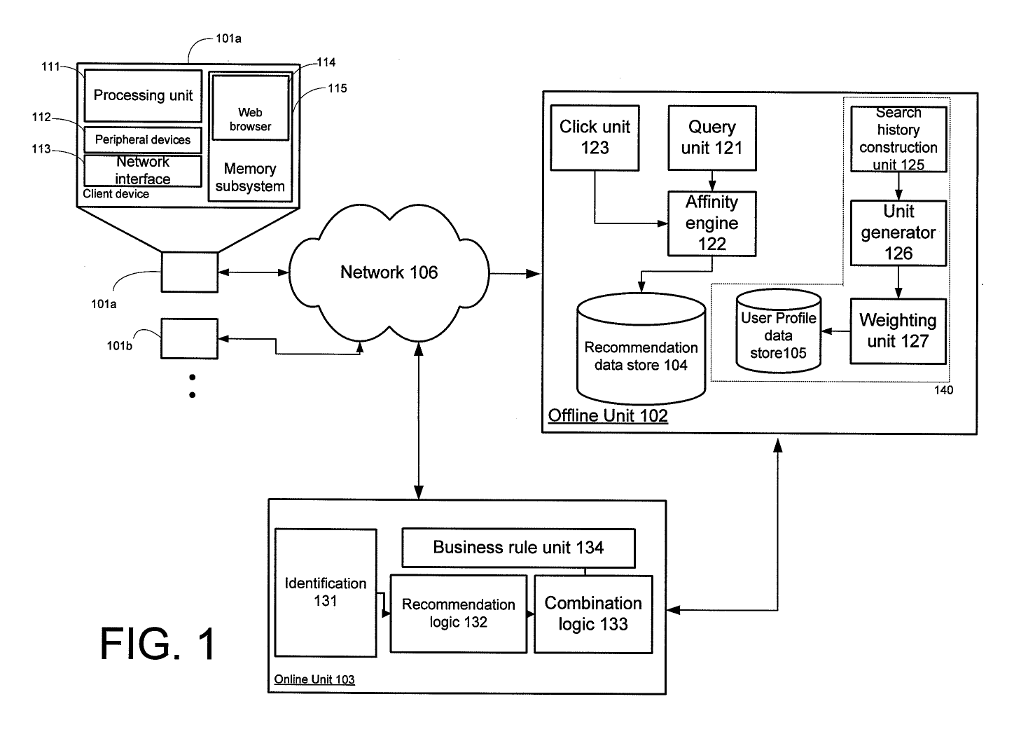

FIG. 1 presents a block diagram illustrating one embodiment of a system for generating recommendations for users based on search queries. According to the embodiment of FIG. 1, a system for generating recommendations for users based on search queries comprises one or more client devices 101a and 101b, an offline unit 102, an online unit 103 and network 106.

According to the embodiment illustrated in FIG. 1, client devices 101a and 101b are communicatively coupled to a network 106, which may include a connection to one or more local and wide area networks, such as the Internet. According to one embodiment of the invention, a client device 101a and 101b is a general purpose personal computer comprising a processor 111, transient and persistent storage devices 115 operable to execute software such as a web browser 114, peripheral devices (input/output, CD-ROM, USB, etc.) 112 and a network interface 113. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

The offline unit 102 is responsible for generating aggregate recommendations and statistics regarding user activity over a defined range or criterion. In one embodiment, the offline unit 102 is operative to generate recommendations and statistics independent from current user activity. Specifically, the offline unit 102 may be operative to be utilized outside of a current web session initiated by any given user.

The offline unit 102 operates on user search queries and associated click data stored on the server (not shown), which may include aggregate search query and click data. In one embodiment, click data corresponds to the links in a search result set that a user selects after entering a search query. For example, if a user enters the search query “Canon Camera” and upon receiving the search results selects the item “Canon SLR” (corresponding to a Canon SLR camera) the search query “Canon Camera” is associated with click data “Canon SLR” and stored in a user profile data store 105.

The query unit 121, affinity engine 122 and click unit 123 comprise an offline recommendation system operative to form a recommendation model for a given environment. For example, if a recommendation model is to be generated for an online shopping site, the offline recommendation system may utilize user search queries and click data associated with the online shopping site.

When generating a recommendation model for a particular site, the query unit 121 and the click unit 123 are operative to fetch historical search queries and associated click data, respectively, from the data store of archived data. Query unit 121 and click unit 123 are operative to fetch data on the basis of specific criteria that a user or application specifies. For example, if a recommendation model is to be generated for an online travel site during the winter months (e.g., November-February 2007), user search queries and click data corresponding to previous summer months (i.e., June-August 2006) would render an inaccurate recommendation model. To correct this, a user or application may specify a specific time period to collect user search queries and click data (e.g., November-February 2006). This ensures that relevant search data is utilized. After the query unit 121 and click unit 123 gathers the relevant user search queries, the queries are sent to affinity engine 122.

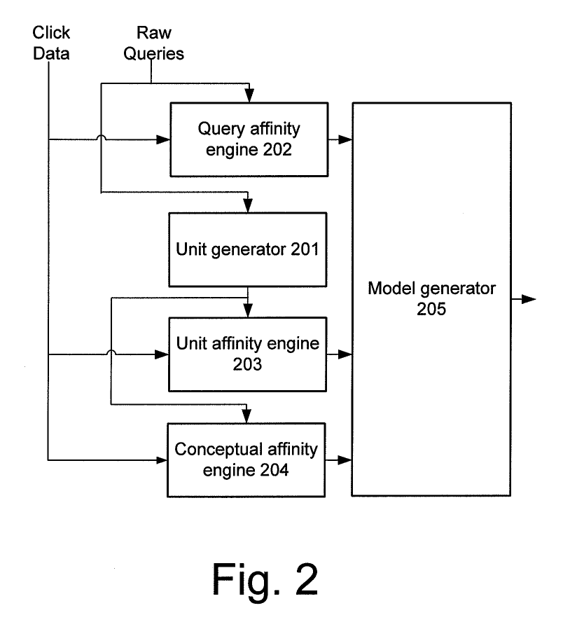

FIG. 2 illustrates an affinity engine in accordance with one embodiment of the present invention. The affinity engine may be broken down into three subcomponents, the query affinity engine 202, the unit affinity engine 203 and the conceptual affinity engine 204. The query affinity engine 202 may be operative to receive a raw query and the associated click data and form associations between the raw queries and the associated clicks. The query affinity engine represents a precise association between user searches and click data, as there is no loss of detail in associating the search with the clicked results. For example, if a user searches for “Wireless card for PC” and clicks on an item “Linksys”, a one-to-one associated is created between the terms “Wireless card for PC” and “Linksys”.

The conceptual affinity engine 204 is operative to receive the raw query and click data and to generate conceptual associations between the search query and the clicked items. The conceptual affinity engine extends the units generated by unit generator 201 and forms association rules based on this extension. For example, a user search query may contain the terms “Canon Camera SLR,” which may be broken down into units “Canon,” “Camera” and “SLR”. The conceptual affinity engine 204 may generate associations based on extending individual units, such as extending the unit “Canon” to “Canon Digital Camera”. The generation of units from search queries is described in greater detail in the applications incorporated herein by reference in their entirety.

The unit affinity engine 203 is operative to receive raw query and click data and to generate corresponding units from the query, as well as generate recommendations for the units. Unit generator 201 is operative to extract relevant logical blocks of data from one or more queries to represent the queries as a groupings of frequently co-occurring words. For example, a user may type a query of “w1 w2 w3”, where w1, w2 and w3 correspond to three separate words or search terms. Assume that from this query, three units are present, “w1 w2”, “w2 w3” and “w1 w2 w3”. These three units are checked against a dictionary and those present within the dictionary are utilized to form a unitized version of the query.

Units generated from user queries are checked against a dictionary. A dictionary may comprise a list of units corresponding to the site with which the dictionary is being utilized. For example, an online shopping site may utilize a dictionary containing units relevant to the products being sold and an online travel site may contain units corresponding to airlines, hotels, car rentals, etc. One method of determining units from a given query is to isolate all possible units and check them against a given dictionary. A pseudo-code implementation of one embodiment of this algorithm is shown below in Table 1:

TABLE 1
0 // Input: User search Query Q; dictionary D. Output: a set of units,
Result_units
1 Tokenize the search query Q ← w₁ + w₂ + ... + wₙ;
2 Result_units ← { };
3 length ← 1;
4 While (length ≦ n)
5 enumerate all possible substrings of Q with size = length, denoted
as Q′
6 if (Q′ exists in D)
7 Result_units ← {Q′} ∪ Result_units;
8 len ← len + 1;

As shown in Table 1, a unitizing algorithm receives a user search query Q and a dictionary D and outputs a set of units Result_units (line 0). For exemplary purposes, assume that Q represents the query “Wireless cards for a PC” and the dictionary D represent a dictionary containing the words “Wireless cards” and “PC”.

The search query Q may be tokenized into N terms: w₁ through wₙ (line 1). Result_units is initialized to an empty set and length is initialized to 1 (lines 2-3). A while loop is then executed (lines 4-8) which executes N times. The purpose of the while loop is to enumerate all substrings of Q that are of length N, for all values of length between 1 and N. For example, during the first iteration (length=1), all terms of length 1 are identified (“Wireless”, “cards”, “for”, “a” and “PC”) (line 5). Of this list, all terms are compared with a dictionary D containing relevant units (line 6). For this example, the term “PC” matches an entry in the dictionary and is thus added to Result_units (line 7). Subsequently, during the second iteration (length=2), the term “Wireless cards” is matched to a dictionary entry, and the Result_units set is updated to contain both “PC” and “Wireless cards”.

The exemplary algorithm of Table 1 detects units within a query that exist in a dictionary. However, it requires a considerable amount of time when a large number of queries are to be analyzed. An alternative algorithm for detecting units within a query is a is illustrated below in Table 2:

TABLE 2
0 // Input: User search Query Q; dictionary D. Output: a set of units,
Result_units
1 Tokenize the search query Q ← w₁ + w₂ + ... + wₙ;
2 Result_units ← { };
3 Longest allowable ← k;
4 length ← 1; i = 0;
5 While (there exists unchecked words in Q)
6 Get the left most k words from the unchecked part of Q (i.e., Qₖ ←
wᵢ+wᵢ₊₁+...wⱼ, where j=i+k−1 if (i+k−1)<n; otherwise j=n;
7 Check Qₖ against D
8 If Qₖ exists in D
9 Result_units ← {Qₖ} ∪ Result_units
10 i ←i+k
11 Otherwise
12 check Qₖ₋₁, Qₖ₋₂, ..., Q₁ against D;
13 add all the matched Qₕ ((k−1)≧h≧1) to Result_units;
14 set i correspondingly;
15 if none of Qₖ, Qₖ₋₁, Qₖ₋₂, ..., Q₁ matches against D,
16 i ← i+1;

For the algorithm illustrated in Table 2, assume a search query Q=“Wireless card for PC”, a dictionary D containing the units “Wireless card” and “PC” and a longest allowable unit value k=2.

A query Q may tokenized into an array or similar structure of words (e.g., “wireless”, “card”, “for” and “PC”) (line 1). The variables Result_units, Longest allowable and length are then initialized accordingly (line 2-4). While there exists words that are unchecked in the query (line 5), the left most k words are chosen from the unchecked part of Q. For this example (k=2), the first iteration fetches the words “Wireless” and “card” (line 6). This phrase is then compared against the dictionary D (line 7) which evaluates to true, that is, “wireless card” appears in the dictionary (line 8). The unit is added to the results list and the value of i (the starting word) is incremented. Since a result was found, lines 11-16 are bypassed and another iteration is performed.

On the second iteration (i=1), the next two words (k=2) are chosen starting from the index i (i=1). Thus the words “card” and “for” are selected forming the unit “card for”. This unit is checked against the dictionary and a match is not found. The algorithm then proceeds to remove words from the end of the current query (“card for”) until the length of the query is 1 (line 12). In this example, after “card for” does not generate a match, the phrase “card” is checked. If a subset of the original unit is found it is added to the results list and the value of i is updated (lines 13-14). In this case, both “card” and “card for” are not found, therefore, no entry is added to the Results_unit and the value “i” is incremented (lines 15-16). The preceding algorithm repeats starting at each word corresponding to the index “i”.

After a query is unitized, associations are determined utilizing the click data. For example, a query of “Wireless card for a PC” may be unitized into the units “wireless card” and “PC”. If the click data indicates the user selected an item with the name “Linksys”, the units “wireless card” and “PC” may both be associated with the item “Linksys”. The model generator 205 receives recommendations from the query affinity engine 202, unit affinity engine 203 and conceptual affinity engine 204. In one embodiment, the model generator may purge the duplicate unit-item pairs. For example, a unit-item pair (“PC,” “Apple”) may be duplicated by the unit affinity engine 203 (“PC” being a unit) and the conceptual affinity engine 204 (“PC” also being a concept).

Referring back to FIG. 1, the recommendation model formed by affinity engine 122 may be stored in a recommendation data store 104. The recommendation data store may comprise a flat file data structure (e.g., tab or comma separated value file), relational database, object oriented database, a hybrid object-relational database, etc. Additionally, the recommendation data store 104 may be accessible by the online unit 103.

In addition to the components of the offline unit 102 hereto fore described, the offline unite 102 may also comprise a user profile generator 140 comprising a search history construction unity 125, a unit generator 126 and a weighting unit 127. In accordance with one embodiment, the user profile generator 140 is operative to analyze archived records of a search history for a given user to formulate an accurate profile of his or her browsing habits. Typically, a search engine (such as Yahoo! search) maintains search histories of users conducting searches using the search engine.

The search history construction unit 125 gathers a search query history for a given user. The search history construction unit 125 may be operative to retrieve a set of search queries corresponding to a specific user and based on predetermined criteria. In one embodiment, a search history construction unit 125 may be configured to extract user queries from within a specified time period. For example, if a user has many searches in the past, the time window may be defined as a shorter time window than a time window for a user with fewer searches in his or her search history. According to an alternative embodiment, a search history construction unit 125 may be configured to extract user queries through time decay based re-weighting.

After the search history construction unit 125 selects a subset of queries from the history of search queries for the given user, the queries may be unitized by the unit generator 126. The unit generator 126 may utilize a site-specific dictionary to unitize search queries for the given user via a unitizing algorithm such as the left-longest algorithm or all-possible algorithm as described previously. In a one embodiment, the unit generator 126 selects an algorithm that corresponds to the algorithm utilized by the offline recommendation system. That is, if the offline recommendation system utilizes the all-possible algorithm, the unit generator 126 may be configured to generate units from user search queries via the same algorithm. Additionally, the time frame selected by the search history construction unit 125 should be used in defining the range of aggregated units comprising the dictionary. For example, if a time frame of user search queries is defined to be 30 days, the units dictionary used by the unit generator 126 comprises a dictionary of units aggregated over the same 30 day time period.

In addition to unitizing search queries, unit generator 126 may be operative to assign frequencies to a given unit generated for a query. In a one embodiment, unit generator 126 is operative to store a table of units generated during the unitization process. After a query has been unitized, a given unit may be compared with the previously generated units stored in the table. If the unit already exists in the table, the frequency value associated with the unit is incremented. If the unit does not exist in the table, the unit is added to the table and its frequency is initialized. For example, consider a unit table during the processing of user queries:

TABLE 3

| Term | Frequency |
|---|---|
| PC | 34 |
| Keyboard | 15 |
| Monitor | 8 |
| Graphics Card | 12 |

If the unit generator receives a query “Wireless card for PC”, the query will be broken down into the units “Wireless card” and “PC”. The unit generator will then compare the units to the table to determine the unit frequency. “Wireless card” has not been entered into the unit table and will thus be added with a frequency of one. “PC” has already been entered into the unit table and thus, its frequency will be incremented. The resulting unit table is shown below:

TABLE 4

| Term | Frequency |
|---|---|
| PC | 35 |
| Keyboard | 15 |
| Monitor | 8 |
| Graphics Card | 12 |
| Wireless Card | 1 |

According to alternative embodiments, the unit table may be sorted by term, by frequency, or any other methods known in the art.

The unit generator 126 generates a table of units with associated frequencies, the table corresponding to a subset of a user's search query history. This table is then sent to the weighting unit 127, which may be operative to assign a weight to a given unit entry stored within the unit table. The weight assigned to a given unit may be utilized to assign the “clickability” of a unit. In a one embodiment, an equation for determining the weight of an individual unit is as follows:

$${w}_{i} = \frac{{c}_{i} + 0.5}{{f}_{i}} \cdot \frac{log ( {f}_{i} + 0.5 )}{log ( {f}_{i\_overall} + 0.5 )} \qquad Equation 1$$

As illustrated in Equation 1, fᵢ refers to the frequency of a given unit i, −fᵢ_{_{—}}ₒᵥₑᵣₐₗₗ refers to the overall frequency of a unit i in the dictionary and cᵢ represents the number of clicks a user makes in the same session of the search unit i. Equation 1 allows for the dynamic modification of the value of a weight of a given unit based upon when the statistics are generated. That is, both

$$\frac{{c}_{i} + 0.5}{{f}_{i}} and \frac{log ( {f}_{i} + 0.5 )}{log ( {f}_{i\_overall} + 0.5 )}$$

may change dynamically. Specifically,

$$\frac{log ( {f}_{i} + 0.5 )}{log ( {f}_{i\_overall} + 0.5 )}$$

captures the changes happening in the distribution of units both at the global and individual level as the individual frequency fᵢ and the global frequency fᵢ_{_{—}}ₒᵥₑᵣₐₗₗ inherently change as a function of time. Additionally,

$$\frac{{c}_{i} + 0.5}{{f}_{i}}$$

tracks the click propensity cᵢ associated with a unit, which changes upon a user clicking additional items during a search containing the corresponding unit.

Equation 1 illustrates a weighting function based on a window of user activity. Additionally, an entire user history may be utilized by introducing a time decay factor multiplied with Equation 1, which Equation 2 illustrates:

$$a = {e}^{- \frac{{T}_{0} - {T}_{1}}{Δ T}} \qquad Equation 2$$

Equation 2 represents a time decay function utilized to exponentially rank user search queries. T₀ represents the time when the model is trained, T₁ represents the time when the search containing the unit occurs and ΔT defines how large the decay will be, that is, the larger the value of ΔT, the slower the decay. The resulting weighting function is as follows:

$${w}_{i} = {e}^{- \frac{{T}_{0} - {T}_{1}}{Δ T}} \cdot \frac{{c}_{i} + 0.5}{{f}_{i}} \cdot \frac{log ( {f}_{i} + 0.5 )}{log ( {f}_{i\_overall} + 0.5 )} \qquad Equation 3$$

Equations 1 and 3 represent weighting functions in accordance with embodiments of the present invention. Un alternative embodiments, however, other discrete or continuous weighting functions as known to those of skill in the art may be implemented.

After the unit table is assigned weights corresponding to units stored therein, the resulting table is stored in the user profile data store 105 for subsequent use by the online unit 103. The user profile data store 105 may comprise a flat file data structure (e.g., tab or comma separated value file), relational database, object oriented database, a hybrid object-relational database, etc.

The online unite 103 accesses the recommendation data store 104 and user profile data store 105, which may comprise accessing in real time, to generate recommendations on the basis of the user profile generated for the user, as well as the association rules created during the offline model training processes performed by the query unit 121, the affinity engine 122 and click unit 123. The online unit may be activated upon a uses request for data from a service enabling the use of an online recommendation system.

When a user accesses an online recommendation unit 103 an identification of the user is transferred to the unit. The identification of a user may be stored in a cookie or similar data file capable of transmitting a form of identification to the online unit 103. In one embodiment, a cookie is transmitted from the client device 101a and 101b to the identification unit 131 containing an encrypted user ID. The identification unit 131 receives the identification file from the user via network 106. The identification unit uses a user ID stored within an identification file to access the user profile data store 105. In one embodiment, the user ID supplied to the user profile storage 105 is utilized to index a table of users with associated user profiles. The identification unit 131 is further operative to retrieve the set of association rules created during the offline model process from recommendation storage 104.

The recommendation logic 132 searches for a direct match to the raw query within the recommendation data store 104. A match for the exact query within the recommendation data store 104 represents a degree of relevancy of a given recommendation. For example, if a user enters the query “Canon Camera SLR”, an initial search is done on recommendation storage 104 to see if the exact query exists and contains an associated recommendation term. If a recommendation is found for the raw query, the recommendation is provided to the user and the online unit bypasses the combination logic 133. If a raw query does not match a recommendation in recommendation storage 104, the query must be broken down into units to provide a higher level of abstraction, e.g., greater granularity.

If an exact match for the raw query is not found, the user profile must be fetched from the profile data store 105 to generate recommendations based on the units comprising the raw query. The user profile containing units with associated frequencies and weights and the offline association rules are returned to the recommendation logic 132. The recommendation logic 132 determines units and association rule to apply given a units profile for the given user and a set of applicable rules associated therewith. In accordance with one embodiment, association rules are given as “UNIT A←ITEM B” and multiple rules may exist for the same UNIT A. Therefore, multiple associations may be made for a single unit.

After the associated items are associated with the units, the unit-item pairs are sorted based on the confidence of the rule. For example, if a unit “PC” is associated with two items, “Apple” and “Penn Central”, the item “Apple” will be moved to the top of the list, as the confidence interval will be greater for the term “Apple” being more relevant than “Penn Central” when a user searches for “PC”.

When the one or more items are sorted for a given unit, the individual units are sorted according to their weights. As described previously, a given unit may be assigned a weight during the profile processing phase. This weight may be used to sort the list of units received by the online unit 103, thereby enabling the list to be sorted such that the most relevant terms are located at the top of the list. For example, if a user searches for the term “PC” a total of 100 times in a month and the term “Wireless” a total of 10 times a month, it is clear that the weight of “PC” is higher than “Wireless”, and thus recommendations for PC related items will be more relevant.

The recommendation unit 132 also selects a relevant subset of units and recommendations from the compiled list of items. A subset is utilized to minimize the effect of search anomalies (e.g., one-time searches) and irrelevant items. In one embodiment, a method of isolating a subset of units and items is to utilize two parameters to iterate through the list. A first parameter “m” may specify how many units to utilize starting at the top of the list. For example, a value of 4 will specify to only use the first 4 items in the list. This value controls the weight of the units being used and will eliminate search anomalies, such as one-time searches. A second parameter “n” may specify how many association rules to utilize for each unit. Thus, a value of 2 specifies to only use the first two association rules for a unit, the first two having the highest confidence interval. This value aids in eliminating errant results formed by weak associations, such as retrieving “Apple” instead of “Penn Central” in the previous example.

In an alternative embodiment, a threshold may replace the value of “m” utilized to determine the number of units to be used. In this embodiment, a weight threshold is defined for the unit list. For example, a threshold of 5 eliminates those units whose weight is lower then 5, thus eliminating less relevant terms.

The combination logic 133 is responsible for forming a union between the units and recommendations generated by recommendation logic 132. The recommendation logic 132 generates multiple units containing multiple associated items, which the combination logic 133 receives and uses to create a unionized list of recommendations. Table 5 illustrates one embodiment of a method for determining the units to comprise the unionized list:

TABLE 5

1 k ← 1; i ← 1;
2 from recommendation list Lᵢ
3 retrieve the current top item ITEMₖ in the Lᵢ;
4 r ← ITEMₖ
5 if # of unique items in r < n, , i ← i + 1,
6 if i < # of lists goto line 2
7 if i = # of lists, k ← k + 1, goto line 2
9 else, goto line 10
10 sort r, remove lower-rank duplicated item

In line 1, looping variables “k” and “i” are initialized to one. A recommendation list L is retrieved in accordance with the variable “i” (line 2). The current top item in L is retrieved (line 3). This item contains the highest confidence value of all recommendations. Next, the item is stored in the result recommendation list “r” (line 4). A check is performed to see if the number of unique items in “r” is less than a predetermined threshold n (line 5). It is important to note that duplicate recommendations may exist within the recommendation list, as units may be associated with the same item. For example, “iPod” may be associated with “Apple” and “Macbook” may also be associated with “Apple”.

If the check passes (the number of unique items is less than the threshold) a second check is performed to determine the position in the list of recommendation lists (lines 6-7). A first check is performed to determine if there are more lists to be checked in the current iteration (line 6). If so, the list number is incremented and the process begins again for the next list. If the current list is determined to be the last list, the value of “k” corresponding the currently active recommendation position is incremented and the process begins for other lists (line 7). When it is determined that the number of unique items in the final recommendation list meets a predetermined criterion (line 5), the duplicate items may be removed from the final recommendation list and the resulting recommendation list is presented (line 10).

In an alternative embodiment, a score may be assigned to a given recommendation that is a function of the confidence in the recommendation, lift, or a combination of both. Table 6 illustrates one embodiment of a pseudo-code example of a combination algorithm:

TABLE 6
1. For all recommendation lists Lᵢ, set threshold of score
2. Only keep those items with score > threshold
3. Mix all items in all lists and sort them by descending order of score
4. For duplicated item, use max(s₁, s₂...) as the score of the item
5. Pick top n items with highest scores in the list

In line 1, a threshold score is assigned to a list. For example, a threshold may be determined to be a confidence interval of 75% (line 1). Each list of recommendations is then parsed to remove all recommendations lower than the defined threshold (line 2). The resulting list of recommendations containing a score higher than the predetermined threshold is then sorted by descending order of score (line 3). The resulting list may contain duplicate items with differing scores, corresponding to duplicate items for different units. The recommendation with the highest score is selected from the duplicates and the remaining recommendations with lower scores are removed (line 4). Finally, the top “n” items with the highest scores are then selected from the list, wherein the value of “n” may be the maximum size of the recommendation list (line 5).

Interacting with both the recommendation logic 132 and the combination logic 133 is the business rule unit 134. The business rule unit 134 is operative to apply editorial rules to the operations of the recommendation logic 132 and combination logic 133. The business rule unit 134 imposes restrictions not found in the user profile or association rules. For example, business rules applied to the recommendation logic 132 may filter out certain items in a raw recommendation list. Business rules applied to the combination logic 133 may adjust the rank of recommended items to promote certain items to the top of the list. The use of business rule unit 134 allows the online model to provide customized recommendations on the basis of rules set by the owner of the server-side system.

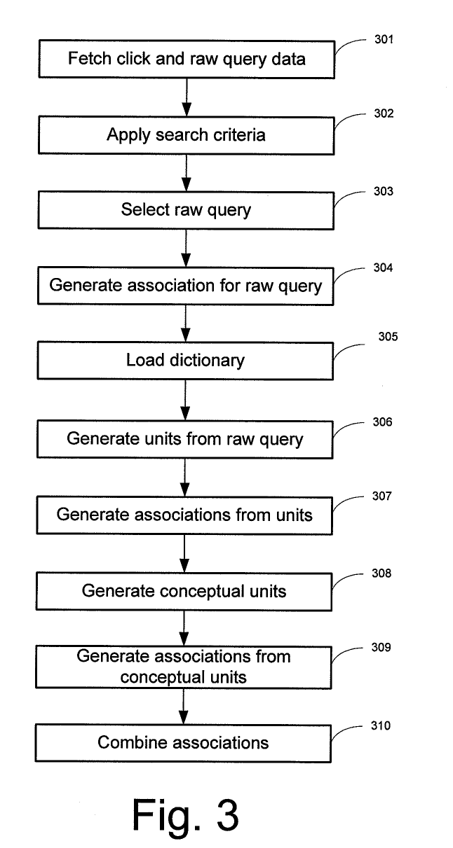

FIG. 3 illustrates a flow diagram depicting a method of generating association rules based on aggregated search queries and associated click data in accordance with one embodiment of the present invention. User search queries and associated click data are fetched in step 301. The user search queries and associated click data correspond to aggregated data gathered for users of a particular application. For example, step 301 may fetch user queries and click data from a specific website, such as an online shopping retailer. Search queries may correspond to searches performed by users to locate items, and click data may correspond to the items the user selects after search results are returned.

A search criterion is generated to select a subset of the entire data set fetched, step 302. This search criterion may correspond to a date range to select data from. For example, user behavior two over months prior to the fetch data may not correspond to the current user behavior, such as during a holiday buying season. Thus an exemplary search criterion for December may be all data falling between November and December of the previous year.

For remaining queries in the subset, a given raw query is selected from the list of queries, step 303, and, after a query is selected, an association is formed between the raw query and the click data, step 304. For example, if a raw query contains “Wireless card for PC” and a user selects an item “Linksys” an association may be given as “Wireless card for PC”←“Linksys”. Raw query association is an exact association to the user click data and therefore generates accurate associations.

After generating a raw query association, a dictionary is loaded for unit generation, step 305. The dictionary loaded in step 305 may contain a list of units that are used to extract units from the raw query. A dictionary loaded in step 305 may be specific to the application utilizing the present method. That is, a dictionary for an auto parts retailer should not contain units corresponding to the food service industry.

Units are generated from the raw query using the dictionary and a unit generating method, such as those illustrated previously, step 306, and, after the units are generated for a raw query, associations are made between items and the generated units, step 307. For example, a raw query, “Wireless card for PC” may be broken into units “Wireless card” and “PC”. The unit “Wireless card” may be further associated with multiple models of wireless cards and the unit “PC” may be further associated with multiple types of personal computers.

After units are associated with items, a raw query may be broken into conceptual units, step 308, which according to one embodiment represent a broader description of the original search query. For example, a raw query “Canon Camera SLR” may be broken into a conceptual unit “Canon Digital Camera”. This unit may be associated with an item to form a higher level of abstraction between a raw query and a generic recommendation that is relevant to the query, step 309. Following this, the three associations are combined to form a resulting recommendation, step 310, and the process ends. The resulting recommendation assures that a relevant recommendation is provide regardless of the level abstraction used to categorize a user query.

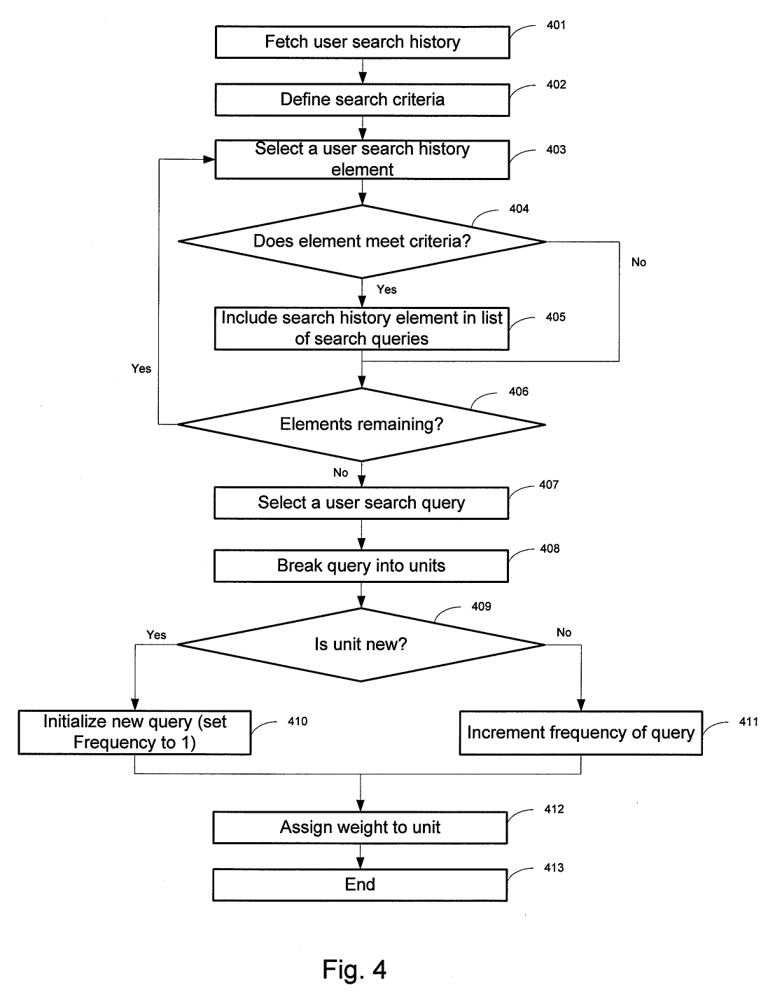

FIG. 4 illustrates a flow diagram depicting a method of generating an offline user profile in accordance with one embodiment of the present invention. As described above, generating an offline user profile characterizes behavior for an individual user. The result of this method may be combined with the global rules generated by the method of FIG. 3 to provide relevant recommendations to a user.

An individual's search history is fetched, step 401, and search criteria applied that is related to the fetched history, step 402. An exemplary history may contain the following queries of Table 7:

TABLE 7

| Timestamp | Query |
|---|---|
| Sat Dec 10 13:45:15 2005 | wireless card for PC |
| Sun Dec 11 09:15:55 2005 | PC graphics card |
| Fri Jun 02 18:31:41 2006 | birthday card for sister |

As Table 7 illustrates, the search criteria may comprise a range of dates for examination, such as search queries for a user during the Winter months of November 2005 to February 2006. In alternative embodiments, the search criteria need not be applied. In these embodiments, user behavior is characterized over search queries entered by the user during the duration of search query monitoring.

After the application of any desired search criterion, an individual search history element may be selected from the history, step 403. For example, the query “wireless card for PC” may be selected from among the queries in Table 7. The selected query may then be compared against the search criterion to determine if the selected query satisfies the search criterion, step 404. For example, if the search criterion consisted of a date range of November 2005 to February 2006, the selected query “wireless card for PC” would be a valid selection and execution of the method advances to step 405. If, however, the selected query was “birthday card for sister” and having a date of Jun. 2, 2006, the selected query would be ignored and a subsequent query would be fetched, step 403. If a search query meets the search criterion defined in step 404, it is added to a list of all valid search queries, step 405, and the user search history is inspected to determine if there are any remaining queries in the history, step 406. If there additional queries remain for processing, processing returns to step 403 and the method repeats.

Upon considering one or more queries in the user history, one or more valid queries are selected from the list of valid queries, step 407. A given selected query is decomposed into a set of one or more units, step 408. The decomposition of queries may follow the method of decomposition utilized by the offline recommendation system. For example, if the offline recommendation system utilizes the all-possible algorithm illustrated in Table 1, the user search queries may be unitized by this same algorithm in step 408. For example, given a search criterion of November 2005 to February 2006, the queries “wireless card for PC” and “PC graphics card” are selected from the user search history. A dictionary utilized by the method of FIG. 4 may contain the units “wireless card”, “graphics card” and “PC”. Given this dictionary, the final list of units will be “wireless card”, “PC”, “graphics card” and “PC”.

A unit table containing previously inspected units may be queried to determine whether a unit has already been added to the unit table, step 409, e.g., is the unit a new unit. In the example above, the units “wireless card”, “PC”, “graphics card” and “PC” are received at step 409. The first three units are searched for and are not found within the unit table, thus a new unit must be initialized for a given unit, step 410. Upon receiving the fourth unit (the second occurrence of “PC”), it is detected that there already exists an occurrence of the term “PC”. Thus, the unit is not added to the table, but the frequency of the existing unit “PC” is incremented by one, step 411.

After valid units are added to the unit table, weights may be assigned to one or more of the valid units, step 412. According to one embodiment, the weighting function is a function of the frequency of each unit, and thus is updated every time the user profile is updated. Exemplary weighting functions are given in Equations 1 and 3. After the units are assigned appropriate weights, the algorithm is terminated and the user profile is marked as completed, step 413.

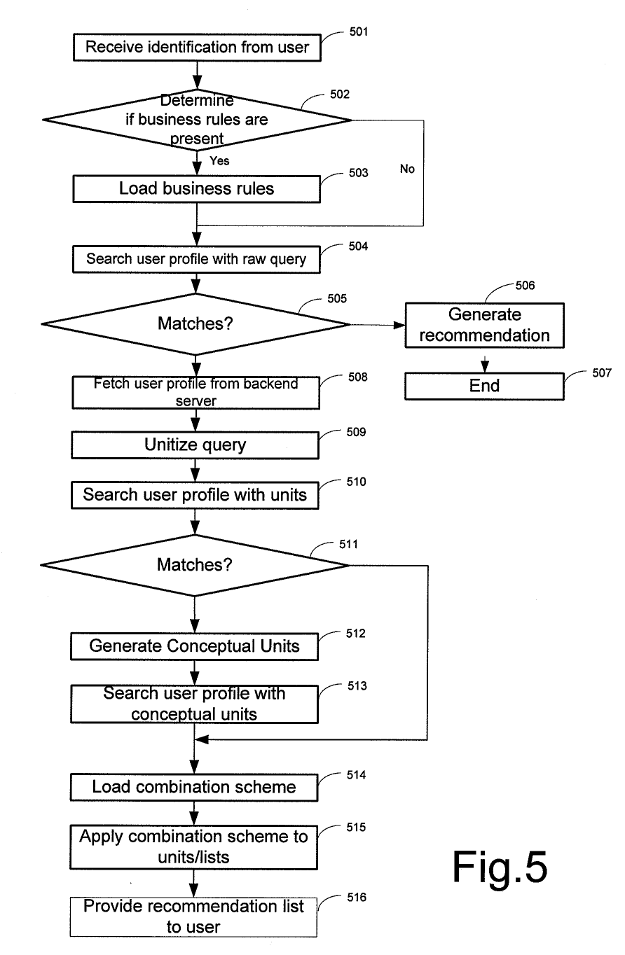

FIG. 5 illustrates a flow diagram depicting a method for generating recommendations in response to a user query in accordance with one embodiment of the present invention. When a user enters a search query an identification file, such as a cookie, is received, step 501. After the identification is received, a determination may be made as to whether business rules are present, step 502. Business rules may impose restrictions not found in the user profile or association rules and, if found, are applied to the remainder of the process, step 503. If business rules are not present, the process bypasses step 503 and proceeds to step 504.

After the business rules have been loaded, step 503, or a determination is made that business rules are not present, step 502, the raw query is used to determine if suitable recommendations are present, step 504. For example, if a user searches for “Wireless card for PC”, this entire query may used to index a listing of recommendations of items. Given the previous query, a plurality of items may be returned. For example, items named “Linksys Wireless-G WCF54G” and “Linksys Wireless-G MIMO Notebook Card” may be a recommended item corresponding to the query. These recommendations represent the highest level of detail, a direct match to a query. After these recommendations are generated, the process ends, step 507.

If no recommendation is found that corresponds to the raw query, the previously generated user profile may be retrieved from a profile data store, step 508. As previously described herein, the user profile may contain an analysis of one or more unitized queries for the given user, which may comprise respective weights and frequencies. After the user profile is retrieved, step 508, the requested query is unitized, step 509.

The unitized query may be utilized to search the recommendation data store for a list of recommended items, step 510, with the user profile utilized to determine the relevant units present within the query according to the behavior of the user. For example, if a user searches for “Wireless card for PC” and the units generated comprise “Wireless card” and “PC” having weights of 100 and 20, respectively, the unit “Wireless card” is given more preference and thus the recommended items will favor the unit “Wireless card” more than the unit “PC”.

If no match is found corresponding to the unitized query, step 511, conceptual units may then be generated to search the recommendation list, step 512. As mentioned previously, conceptual units corresponded to a conceptual model based on a user query. For example, if a user enters the query “Canon Camera SLR”, a conceptual unit “Canon Digital Camera” may be generated for use with the recommendation rules. Following the generation of conceptual units, the recommendations are searched using the generated conceptual units, step 513.

After a match is found corresponding the unitized queries in step 511, or the recommendation store is searched with the generated conceptual units, step 513, the units with associated items may be combined to form a finalized list of recommended items. First, a combination scheme is loaded, step 514. The combination scheme is an algorithm designed to select at least one recommendation from the lists corresponding to the searched units. For example, given units U1 and U2, corresponding lists A and B may respectively be generated. Lists A and B may contain multiple items A₁, A₂ . . . Aₙ and B₁, B₂ . . . Bₙ, respectively. The combination scheme is operative to select the most relevant items from these list of prospective items. In an exemplary embodiment, a combination scheme may comprise the algorithm illustrated in Table 8:

TABLE 8

1 k ← 1; i ← 1;
2. from recommendation list Lᵢ
3. retrieve the current top item (itemₖ) in the list Lᵢ;
4. r ← itemₖ
5. if # of unique items in r<n, go to line 6; else goto line 8
6. if i < # of lists, i ← i+1, goto line 2
7. if i = # of lists, i = 1; k ← k+1, goto line 2
8. sort r and remove lower-rank duplicated item

As illustrated in Table 8, variables “k” and “i” are initialized in line 1. A first list is selected (line 2) and the top item of the list is retrieved (line 3) and stored into a result list “r”. If the number of elements in the result list is less than the predefined number of results (“n”), the next list is retrieved (line 5). If the number of items in the result list is equal to the predefined number of results, process breaks to line 8. If the number of items in the result list is less than the maximum, a check is performed to see if the final list is being checked. If the list is not the last list being checked, the next list is inspected and the position of the item (“k”) remains the same (line 6). If the list is the last list to be inspected, the first list is reloaded and the item position is incremented to inspect the next item in each list (line 7). After the maximum number of results is attained, the list is sorted and duplicate items having a lower rank are deleted.

Alternatively, a score-based merge may be performed on the recommendations as illustrated by the exemplary pseudo code of Table 9:

TABLE 9
1. For all raw recommendation list Lᵢ, set threshold of score, only keep
those items with score > threshold
2. Mix all items in all lists and sort them by descending order of score
3. For duplicated item, use max(s₁, s₂...sₙ) as the score of the item
4. Pick top n items with highest scores in the list

In a score-based merge, a threshold may be identified for a given item. A threshold may be a predetermined weight, frequency, confidence, lift or any other statistical parameter as is known to those of skill in the art. After a threshold is set, the recommendation lists are scanned and items below the predetermined threshold are removed (line 1). After items below the threshold are removed, the remaining items are combined into a single list and are sorted in descending order of score (line 2). For a given duplicated item, the item with the highest score is kept while the other items with lower scores are removed (line 3). Finally, the top “n” items (“n” being defined as the number of recommendations to be returned) are selected from the single list and returned.

After the combination scheme is loaded, it is applied to the lists associated with a given unit, step 515. This generates a list of size “n” corresponding to the most relevant units based on the item score and the unit weight. After the n recommendations are generated, the list is provided to the user and the process ends, step 516.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

It is not intended for any term in the specification or claims to be ascribed an uncommon or special meaning unless explicitly set forth as such. Further, the present invention encompasses present and future known equivalents to the known components referred to herein by way of illustration. While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A system for generating relevant recommendations to one or more users based on user search queries comprising:
a network;
at least one client device connected to said network;
a network resource connected to said network;
a recommendation unit operative to generate a recommendation model based on aggregate activity generated with said network resource.
a user profile unit operable to generate statistics related to an individual users interaction with an network resource; and
a recommendation server operable to receive user activity and generate recommendations related to said user activity.

2. The system of claim 1 wherein said recommendation unit further comprises a click unit for capturing user click data and a query unit for capturing user queries, wherein said user click data corresponds to said user queries.

3. The system of claim 2 wherein said recommendation unit further comprises an affinity engine coupled to said click unit and said query unit, wherein said affinity engine is operative to generate a recommendation model based on a received click data and user queries.

4. The system of claim 3 wherein said recommendation unit further comprises a recommendation data store for storage of a recommendation model generated by said affinity engine.

5. The system of claim 3 wherein said affinity engine comprises:
a query affinity engine operative to generate associations between user search queries and click data.
a unit generator operative to receive a search query and extract predefined units from said search query via an extraction algorithm;
a unit affinity engine coupled to said unit generator operative to receive the extracted units and generate associations between units and click data.
a conceptual affinity engine coupled to said unit generator operative to receive the extracted units and generate conceptual units, wherein said conceptual affinity engine is further operative to generate associations between said conceptual units and click data; and
a model generator coupled to said query affinity engine, said unit affinity engine and said conceptual affinity engine operative to combine the associations generated by said query affinity engine, said unit affinity engine and said conceptual affinity engine to form at least one recommendation model.

6. The system of claim 1 wherein said user profile unit comprises:
a search history construction unit operative to retrieve a subset of user search history;
a unit generator coupled to said search history construction unit operative to receive a search query and extract units from said search query via an extraction algorithm;
a weighting unit coupled to said unit generator operative to assigned weights to the units extracted by said unit generator; and
a user profile data store coupled to said weighting unit operative to store said extracted units.

7. The system of claim 6 wherein said subset of user search history is based on a date range.

8. The system of claim 6 wherein said predefined units correspond to a dictionary specific to said network resource.

9. The system of claim 6 wherein said extraction algorithm corresponds to an all-possible algorithm.

10. The system of claim 6 wherein said extraction algorithm corresponds to a left-longest possible algorithm.

11. The system of claim 6 wherein said unit generator further comprises a frequency unit, said frequency unit operative to assign a frequency to a given extracted unit.

12. The system of claim 11 wherein said user profile is operative to store said frequencies.

13. The system of claim 1 wherein said recommendation server further comprises:
an identification unit operative to receive information from a user accessing said network resource;
said identification unit further operative to retrieve said recommendation model and said statistics related to an individual users interaction with an network resource;
recommendation logic coupled to said identification unit operative generate recommendations for the user and select a subset of said recommendations; and
combination logic coupled to said recommendation logic operative to combine said recommendations into a resulting recommendation list.

14. The system of claim 13 wherein said list of recommendations is generated based on a raw user query.

15. The system of claim 13 wherein said list of recommendations is generated based on units generated from a raw user query.

16. The system of claim 13 wherein said list of recommendations is generated based on conceptual units generated from a raw user query.

17. The system of claim 13 wherein said recommendation server comprises a business rule unit, wherein said business rule unit is operative to apply editorial rules to the operations of the recommendation server.

18. The system of claim 17 wherein editorial rules comprise a filter for incoming data.

19. The system of claim 17 wherein editorial rules comprise adjusting a rank parameter for a query.

20. A method for generating relevant recommendations to one or more users based on user search queries comprising:
generating a recommendation model based on aggregate activity generated through use of a network resource;
generating a user profile based on an individual user's interaction with said network resource; and
receiving a user query and utilizing said recommendation model and said user profile to provide a recommendation.

21. The method of claim 20 wherein said recommendation model is formed from user click data and user queries.

22. The method of claim 21 wherein an affinity is determined between a user click and corresponding query.

23. The method of claim 22 further storing said recommendation model.

24. The method of claim 22 wherein said affinity is determined between raw queries and items, between units and items and between conceptual units and items.

25. The method of claim 24 wherein said affinities are combined to form said recommendation model.

26. The method of claim 20 wherein generating a user profile comprises:
retrieving a subset of user search history;
extracting predefined units from said search history via an extraction algorithm;
applying a weight to each extracted unit; and
storing said units in a user profile storage.

27. The method of claim 26 wherein retrieving a subset of user search history comprises selecting a subset based on a date range.

28. The method of claim 26 wherein said units correspond to a dictionary specific to said network resource.

29. The method of claim 26 wherein said extraction algorithm comprises an all-possible algorithm.

30. The method of claim 26 wherein said extraction algorithm comprises an left-longest algorithm.

31. The method of claim 26 wherein generating a user profile further comprises attaching a frequency corresponding to a unit.

32. The method of claim 31 wherein said user profile storage is operative to store said frequencies.

33. The method of claim 20 wherein receiving a user query and utilizing said recommendation model and said user profile to provide a recommendation comprises:
retrieving said recommendation model and user profile from storage;
generating recommendations for a user and selecting a subset of said recommendations; and
combining said recommendations into a final recommendation list.

34. The method of claim 33 wherein said final recommendation list is generated on the basis of a raw user query.

35. The method of claim 33 wherein said final recommendation list is generated on the basis of units generated from a raw user query.

36. The method of claim 33 wherein said final recommendation list is generated on the basis of conceptual units generated from a raw user query.

37. The method of claim 20 comprising utilizing business rules to apply editorial rules to the operation of generating a recommendation based on a user query.

38. The method of claim 37 wherein editorial rules comprise a filter for incoming data.

39. The method of claim 37 wherein editorial rules comprise adjusting a rank parameter for a query.
